(19) United States
(12) Patent Application Publication
(10) Pub. No.: US 2026/0367997 A1
(43) Pub. Date: Nov. 19, 2026

(54) COMPUTING RESOURCE RECLAMATION IN DISTRIBUTED COMPUTING SYSTEMS

(71) Applicant: Red Hat, Inc., Raleigh, NC (US)

(72) Inventors: Damien Eversmann, Springfield, IL (US); Leigh Griffin, Waterford (IE)

(73) Assignee: Red Hat, Inc., Raleigh, NC (US)

(21) Appl. No.: 19/206,543

(22) Filed: May 13, 2025

(51) Int. Cl. G06F 9/50

(52) U.S. Cl. CPC G06F 9/5094

(57) ABSTRACT

In certain aspects, a system can implement dynamic control and reclamation of computing resources. For example, the system may receive first metadata and second metadata. The first metadata may describe one or more historical workloads executed in association with an entity. The second metadata may describe a workload scheduled for execution in a computing environment. The system may further generate an action tolerance breakpoint based on the first metadata and the second metadata. The action tolerance breakpoint may define criteria for reducing an amount of a computing resource of the computing environment allocated to the workload. The system may then execute the workload in the computing environment while controlling allocation of the computing resource of the computing environment to the workload using the action tolerance breakpoint.

### TECHNICAL FIELD

The present disclosure relates generally to controlling computing resources. More specifically, but not by way of limitation, this disclosure relates to reclaiming computing resources in distributed computing environments.

### BACKGROUND

Distributed computing systems (e.g., cloud computing systems, data grids, and computing clusters) have recently grown in popularity given their ability to improve flexibility, responsiveness, and speed over conventional computing systems. A cloud computing system can be implemented using one of several deployment models, such as a private cloud, a public cloud, or a hybrid cloud. A public cloud environment can be created using computing infrastructure that is not owned by an end user.

### BRIEF DESCRIPTION OF THE DRAWINGS

FIG. 1 is a block diagram of an example of a computing environment for reclaiming computing resources according to some examples of the present disclosure.

FIG. 2 is a block diagram of another example of a computing environment for reclaiming computing resources according to some examples of the present disclosure.

FIG. 3 is a flowchart of a method for reclaiming computing resources according to some examples of the present disclosure.

### DETAILED DESCRIPTION

Energy management and computing resource allocation can be challenging in distributed computing systems (e.g., cloud computing systems). Public cloud access, which allows many users to interact with a cloud computing environment, may exacerbate the challenges of energy management and computing resource allocation. For example, a user may deploy a workload in the cloud computing environment and later forget to tear down the workload. As a result, the computing resources of the cloud computing environment allocated to the workload are wasted. Aggressive reclamation policies may be implemented to tear down idle workloads to reduce wastage of computing resources. However, the aggressive reclamation policies may also tear down long running tasks that may be idle for periods of time (e.g., machine learning models). Therefore, there is a need for reclamation policies that can differentiate between abandoned and long running tasks to facilitate efficient usage and allocation of computing resources.

Some examples of the present disclosure can overcome one or more of the issues mentioned above by a task manager that can implement custom and dynamic reclamation policies. For example, the task manager may receive information (e.g., metadata) about an entity and a workload that the entity is running (or is going to run) in a computing environment. The information can indicate previous workloads run by the entity, computing resource requirements of the previous workloads, current computing resource usage of the workload, idle time between actions associated with the workload, etc. Accordingly, using the information, the task manager may identify thresholds and benchmarks (e.g., an idle time threshold, an energy consumption threshold, or the like) for the workload. The task manager may further update the thresholds and benchmarks over time as more information is obtained regarding the workload or other workloads associated with the entity. Moreover, the thresholds and benchmarks may be used by the task manager to generate a reclamation policy for the workload.

Accordingly, the task manager can generate reclamation policies that are customized based on expected behavior (e.g., expected computing resource requirements, idle time between actions, etc.) of workloads and the entities associated with the workloads. As a result, the reclamation policies generated by the task manager can differentiate between a task that is abandoned and a task that is behaving as expected (e.g., is exhibiting an expected amount of idle time between actions). The thresholds and benchmarks of the reclamation policies may further enable computing resource allocation to a workload to be decreased before tearing down the workload. In this way, computing resource waste can be reduced without prematurely tearing down a workload. Thus, using the custom and dynamic reclamation policies generated by the task manager, computing resources of a computing environment can be efficiently used by and allocated to workloads.

In one particular example, the task manager may receive information about historical workloads (e.g., software applications or services) previously run by a user and about a software application that the user is currently running in a computing environment. From the information, first metadata can be identified that includes a number of the historical workloads run by the user, computing resource usage (e.g., central processing unit (CPU), power, and memory usage) of the historical workloads, or other metadata indicative of trends in compute capability usage by workloads associated with the user. Additionally, from the information, second metadata may be identified that includes computing resource usage (e.g., CPU, power, and memory usage) of the software application, idle time between actions performed by the software application, or other metadata indicative of trends in compute capability usage by the software application.

Based on the first metadata (e.g., on expected computing resource usage of the workloads associated with the user), the second metadata (e.g., on expected or ongoing operational expenses, such as computing resource usage, of the software application), and a current and/or expected demand on a computing environment (e.g., due to other workloads running on the computing environment), the task manager may generate action tolerance breakpoints for the software application. The action tolerance breakpoints may each define criteria for reducing an amount of a computing resource (e.g., CPU, memory, storage, or network bandwidth) allocated to the software application.

In the example, a first action tolerance breakpoint may define a first idle time threshold. Thus, the criteria for reducing the amount of the computing resource allocated to the software application is the first idle time threshold. As such, if the software application is idle for a length of time equal to or greater than the first idle time threshold, the criteria is satisfied. Additionally, a second action tolerance breakpoint may define a second idle time threshold that is longer than the first idle time threshold. As such, if the software application is idle for a length of time equal to or greater than the second idle time threshold, the criteria defined by the second action tolerance is satisfied. Moreover, in the example, a third action tolerance breakpoint may define criteria for terminating the software application. For example, the third action tolerance breakpoint may define a third idle time threshold that is longer than the first and second idle time thresholds. As such, if the software application is idle for a length of time equal to or greater than the third idle time threshold, the criteria defined by the third action tolerance is satisfied and the software application may be terminated.

As a result of generating the action tolerance breakpoints, during execution of the software application in the computing environment, the task manager may control allocation of computing resources of the computing environment to the software application using the action tolerance breakpoints. For example, the task manager may monitor the software application and, consequently, detect that the software application has been idle for a length of time equal to the first idle time threshold. In response, the task manager may reduce a power usage of the software application, idle CPU allocated to the software application, and introduce a wait queue. Then, via continuous monitoring of the software application, the task manager may determine that the software application is still idle when a length of time has passed that is equal to the second idle time threshold. In response, the task manager may increase the wait queue. Moreover, via the continuous monitoring of the software application, the task manager may determine that the software application is still idle when a length of time has passed that is equal to the third idle time threshold. Thus, the task manager may terminate the software application (e.g., by deactivating virtual machines or containers used to run the software application, removing computing infrastructure set up for the software application, releasing computing resources allocated to the software application, or a combination thereof).

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

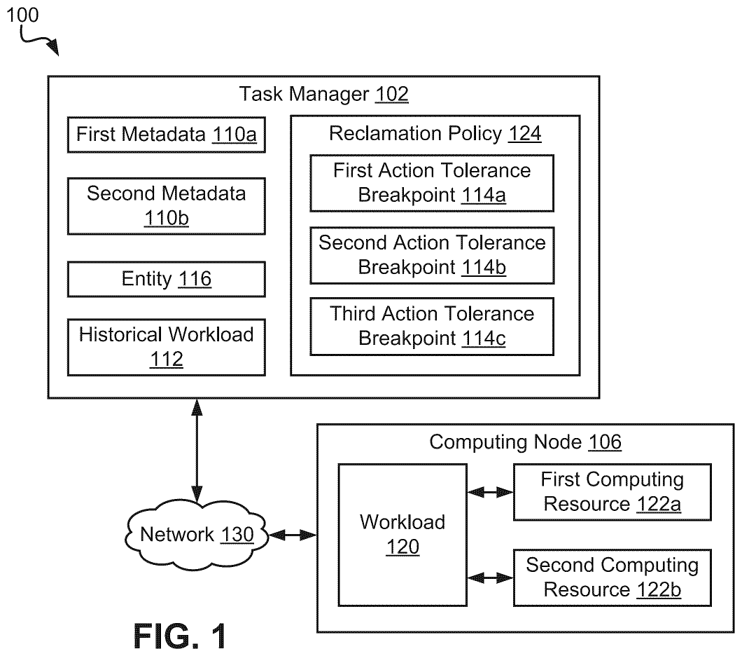

FIG. 1 is a block diagram of an example of a computing environment 100 for reclaiming computing resources according to some examples of the present disclosure. The computing environment 100 can be any type of computing environment such as, but not limited to, an edge computing environment, a distributed computing environment, a cloud computing environment, a personal computing environment, or the like. In the example shown in FIG. 1, the computing environment 100 includes a task manager 102 and a computing node 106. Components within the computing environment 100 (e.g., the task manager 102 and the computing node 106) may be communicatively coupled via a network 130, such as a local area network (LAN), wide area network (WAN), the Internet, or any suitable network.

The task manager 102 may be a server-based software service that may, among performing other operations, generate and implement custom and dynamic reclamation policies. The reclamation policies generated by the task manager 102 may define how to reclaim and/or reallocate computing resources that are being used in an inefficient manner (e.g., to execute an abandoned workload). To generate and implement custom and dynamic reclamation policies, the task manager 102 may identify an entity (e.g., entity 116) associated with each workload to be run in the computing environment 100 (e.g., workload 120). The entity 116 may be any entity that interacts with the computing environment (e.g., with a cloud service of the computing environment) to perform tasks or access information. Examples of the entity 116 include a user, an organization, and a software application. The workload 120 may involve execution of a software application, a software service, an AI model, a batch processing workload, automation software, or the like.

Once the task manager 102 identifies the entity 116, the task manager 102 may receive first metadata 110a associated with the entity 116. The first metadata 110a may describe at least one historical workload associated with the entity 116. For example, the first metadata 110a may identify a historical (e.g., a previously executed) workload 112 (e.g., by including a workload name, version, or the like). The first metadata 110a may further include historical computing resource usage (e.g., CPU, memory, storage, graphics processing unit (GPU), or network usage) of the historical workload 112, scheduling information (e.g., affinity rules, hardware constraints, a time range for execution, etc.) for the historical workload 112, a type of the historical workload 112 (e.g., batch, real-time, or interactive), scalability of the historical workload 112, etc. Thus, by receiving the first metadata 110a associated with the entity 116 for the historical workload 112 (or for more than one historical workload), the task manager 102 may derive trend data indicative of computing resource and energy requirements typically (e.g., historically) used by the entity 116 with respect to a computing environment (e.g., the computing environment 100), typical idle times between actions run by the entity 116, and the like.

Additionally, the task manager 102 may receive second metadata 110b associated with the workload 120. Similar to the first metadata 110a, the second metadata 110b may include historical computing resource usage (e.g., CPU, memory, storage, GPU, or network usage) of a previous execution of the workload 120 (e.g., of a binary equivalent of the workload 120) or of execution of workloads similar to the workload 120 (e.g., a similar type of software application). Moreover, the second metadata 110b may include scheduling information (e.g., affinity rules, hardware constraints, a time range for execution, etc.) for the previous execution of the workload 120 or of execution of the similar workloads, a type of the workload 120 or of the similar workloads (e.g., batch, real-time, or interactive), scalability of the workload 120 or of the similar workloads, etc. Thus, by receiving the second metadata 110b, the task manager 102 may derive trend data indicative of computing resource and energy requirements of the workload 120, typical idle times between actions associated with the workload 120, and the like.

Based on the first metadata 110a (e.g., trend data indicative of computing resource and energy requirements previous used by the entity 116), the second metadata 110b (e.g., on the trend data indicative of computing resource and energy requirements of the workload 120), a current and/or expected demand on the computing environment 100 (e.g., due to other workloads running on the computing environment 100), or a combination thereof, the task manager 102 may generate a reclamation policy 124 that includes action tolerance breakpoints 114a-c. An action tolerance breakpoint may define criteria for reducing an amount of a computing resource (e.g., CPU, memory, storage, GPU, or network bandwidth) of a computing environment allocated to a workload. Additionally or alternatively, an action tolerance breakpoint may define criteria for terminating (e.g., tearing down) a workload such that workload is no longer running in the computing environment 100.

In one example, an action tolerance breakpoint may be an idle time threshold. As such, if a workload is idle for a length of time greater than or equal to the idle time threshold, the amount of the computing resource(s) allocated to the workload may be reduced. In another example, an action tolerance breakpoint may be an energy consumption threshold. As such, if a workload uses an amount of energy (e.g., electricity) greater than or equal to the energy consumption threshold for greater than or equal to a threshold time, the amount of the computing resource(s) allocated to the workload may be reduced. Moreover, in some examples, the action tolerance breakpoint may be a CPU usage threshold, a memory consumption threshold, a storage threshold, or any other threshold or benchmark that can be measured and monitored during execution of a workload with respect to a computing environment.

In a particular example, a first action tolerance breakpoint 114a of the reclamation policy 124 defines a first idle time threshold. Additionally, a second action tolerance breakpoint 114b of the reclamation policy 124 may define a second idle time threshold that is longer than the first idle time threshold. Moreover, a third action tolerance breakpoint 114c of the reclamation policy 124 may define a third idle time threshold that is longer than the first and second idle time thresholds. The reclamation policy may further indicate the computing resources to be reduced for each action tolerance breakpoint, when the workload is to be terminated, or other actions to be performed based on workload behavior in the computing environment 100.

Additionally, the task manager 102 may execute the workload 120 in the computing environment 100. For example, as shown in FIG. 1, the workload 120 may be deployed and executed on a computing node 106 of the computing environment 100. Then, during execution of the workload 120, the task manager 102 may control allocation of one or more computing resources (e.g., computing resources 122a-b) of the computing environment 100 to the workload based on the reclamation policy 124.

For example, the task manager 102 may monitor the workload 120 and, consequently, detect that the workload 120 has satisfied the criteria for the first action tolerance breakpoint 114a (e.g., has been idle for a length of time equal to the first idle time threshold). In response, the task manager 102 may reduce a computing resource allocated to the workload 120. For example, the task manager may reduce power usage of the workload 120 by idling CPU allocated to the workload 120. Additionally or alternatively, the task manager 102 may introduce a wait queue. The wait queue may be a data structure that holds processes or threads associated with the workload 120 until a condition becomes true. For example, the wait queue may hold the processes or threads associated with the workload 120 until the workload is no longer idle (e.g., until the workload is active due to, for example, a user interacting with the workload).

If the workload 120 is activated, the reclamation policy 124 may terminate and the task manager 102 may reallocate computing resources to the workload 120. Alternatively, if the workload 120 satisfies the criteria for the second action tolerance breakpoint 114b (e.g., if the workload 120 is still idle when a length of time has passed that is equal to the second idle time threshold), the task manager 102 may increase the wait queue. Additionally or alternatively, the task manager 102 may further reduce an amount of one or more computing resources of the computing environment allocated to the workload 120. For example, the first computing resource 122a may be memory and the second computing resource 122b may be network bandwidth. Thus, the task manager may reduce memory or network bandwidth allocated to the workload 120.

Moreover, in the particular example and via the continuous monitoring of the workload, the task manager 102 may determine that the workload 120 has satisfied the third action tolerance breakpoint 114c (e.g., is still idle when a length of time has passed that is equal to the third idle time threshold). In response, the task manager 102 may terminate the workload (e.g., by deactivating virtual machines or containers used to run the workload 120, removing computing infrastructure set up for the workload 120, releasing computing resources allocated to the workload 120, or a combination thereof).

The reclamation policies (e.g., reclamation policy 124) generated by the task manager 102 may be highly customizable in terms of aggressiveness. For example, an amount of time a workload is allowed to be idle, an amount of reduction in computing resources, or how quickly a workload is terminated may be customized based on the metadata 110a-b or other information related to the entity 116, the workload 120, and/or the computing environment 100. In a particular example, a reclamation policy can be generated that implements action tolerance breakpoints while maintaining compliance with a service level agreement. Moreover, the task manager 102 may use feedback received during execution of workloads to revise and improve reclamation policies. For example, if a user wakes a workload, it may indicate that an action tolerance breakpoint (e.g., an idle time threshold) associated with the reclamation policy for that workload can be adjusted (e.g., increased).

While FIG. 1 depicts a specific arrangement of components, other examples can include more components, fewer components, different components, or a different arrangement of the components shown in FIG. 1. For instance, in other examples, the computing environment 100 can include a different number of computing nodes. Additionally, any component or combination of components depicted in FIG. 1 can be used to implement the process(es) described herein.

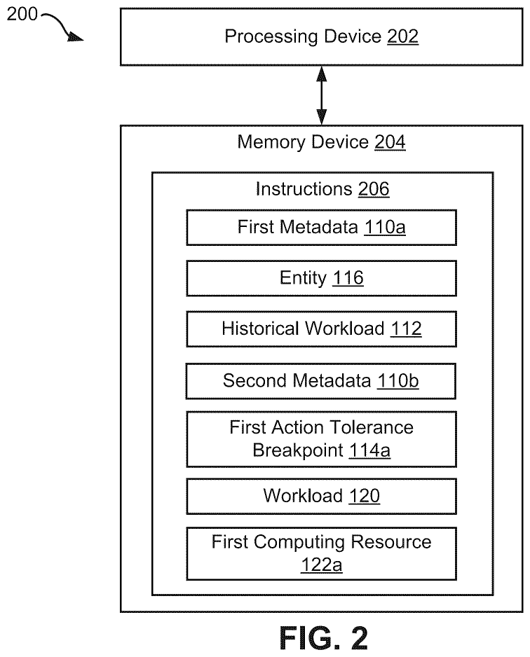

FIG. 2 is a block diagram of another example of a computing environment 200 for reclaiming computing resources according to some examples of the present disclosure. The computing environment 200 can include a processing device 202 communicatively coupled to a memory device 204.

The processing device 202 can include one processing device or multiple processing devices. The processing device 202 can be referred to as a processor. Non-limiting examples of the processing device 202 include a Field-Programmable Gate Array (FPGA), an application-specific integrated circuit (ASIC), and a microprocessor. The processing device 202 can execute instructions 206 stored in the memory device 204 to perform operations. In some examples, the instructions 206 can include processor-specific instructions generated by a compiler or an interpreter from code written in any suitable computer-programming language, such as C, C++, C#, Java, Python, or any combination of these.

The memory device 204 can include one memory device or multiple memory devices. The memory device 204 can be non-volatile and may include any type of memory device that retains stored information when powered off. Non-limiting examples of the memory device 204 include electrically erasable and programmable read-only memory (EEPROM), flash memory, or any other type of non-volatile memory. At least some of the memory device 204 includes a non-transitory computer-readable medium from which the processing device 202 can read instructions 206. A computer-readable medium can include electronic, optical, magnetic, or other storage devices capable of providing the processing device 202 with the instructions 206 or other program code. Non-limiting examples of a computer-readable medium include magnetic disk(s), memory chip(s), ROM, random-access memory (RAM), an ASIC, a configured processor, and optical storage.

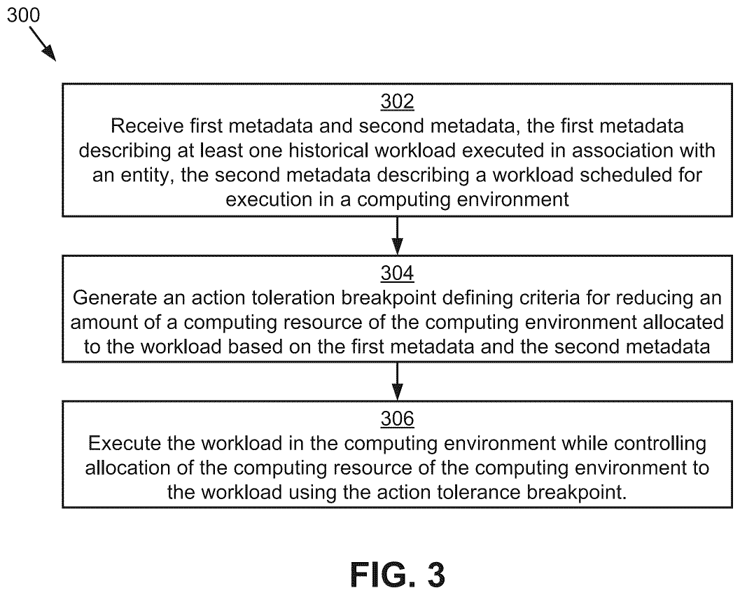

As mentioned above, the processing device 202 can execute the instructions 206 stored in the memory device 204 to perform operations (e.g., any of the operations described above with respect to the task manager 102 or described below with respect to FIG. 3). In an example, the processing device 202 may receive first metadata 110a and second metadata 110b. The first metadata 110a may describe a historical workload 112 executed in association with an entity 116, and the second metadata 110b may describe a workload 120 scheduled for execution in the computing environment 200. Additionally, the processing device 202 may generate an action tolerance breakpoint (e.g., first action tolerance breakpoint 114a) based on the first metadata 110a and the second metadata 110b. The first action tolerance breakpoint 114a may define criteria for reducing an amount of a computing resource (e.g., first computing resource 122a) of the computing environment 200 allocated to the workload 120. The processing device 202 may further execute the workload 120 in the computing environment 200 while controlling allocation of the first computing resource 122a of the computing environment 200 to the workload 120 using the first action tolerance breakpoint 114a.

FIG. 3 is a flowchart of a method for reclaiming computing resources according to some examples of the present disclosure. In some examples, the processing device 202 can perform one or more of the steps shown in FIG. 3. For example, the processing device 202 may execute the task manager 102 of FIG. 1 to perform one or more of the steps shown in FIG. 3. In other examples, the processing device 202 can implement more steps, fewer steps, different steps, or a different order of the steps depicted in FIG. 3. The steps of FIG. 3 are described below with reference to components discussed above in FIGS. 1-2.

At block 302, the processing device 202 can receive first metadata 110 and second metadata 110b. The first metadata 110a may describe at least one historical workload 112 executed in association with an entity 116 (e.g., a user, organization, software application, or the like). The second metadata 110b may describe a workload 120 scheduled for execution in a computing environment 100 (e.g., a cloud computing environment.

At block 304, the processing device 202 can generate an action tolerance breakpoint based on the first metadata 110a and the second metadata 110b. The action tolerance breakpoint may define criteria for reducing an amount of a computing resource of the computing environment 100 allocated to the workload. Additionally, in some examples, the action tolerance breakpoint may be a first action tolerance breakpoint 114a and the processing device may further generate a second action tolerance breakpoint 114b. The second action tolerance breakpoint 114b may, in an example, define criteria for terminating the workload 120.

At block 306 the processing device 202 can execute the workload 120 in the computing environment 100 while controlling allocation of the computing resource of the computing environment 100 to the workload 120 using the action tolerance breakpoint. For example, the processing device 202 may deploy and execute the workload 120 on a computing node 106 of the computing environment 100 or on more than one computing node of the computing environment 100. In some examples, the processing device 202 may deploy and execute the workload 120 using a container, a virtual machine, or the like.

Then, during execution of the workload 120 in the computing environment 100, the processing device 202 may control allocation of the computing resource of the computing environment 100 to the workload 120 using the action tolerance breakpoint. For example, the processing device 202 may detect that the criteria defined by the first action tolerance breakpoint 114a is satisfied based on monitoring the workload 120. In response to detecting that the criteria defined by the first action tolerance breakpoint 114a is satisfied, the processing device 202 may reduce the amount of the computing resource (e.g., power, CPU, memory, storage, GPU, or the like) of the computing environment 100 allocated to the workload 120. Additionally, subsequent to reducing the amount of the computing resource allocated to the workload 120, the processing device 202 may detect that the criteria defined by the second action tolerance breakpoint 114b is satisfied based on monitoring the workload 120. In response to detecting that the criteria defined by the second action tolerance breakpoint 114b is satisfied, the processing device 202 may terminate the workload 120.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A system comprising:
a processing device; and
a memory device including instructions that are executable by the processing device for causing the processing device to perform operations comprising:
receiving first metadata and second metadata, the first metadata describing at least one historical workload executed in association with an entity, and the second metadata describing a workload scheduled for execution in a computing environment;
generating an action tolerance breakpoint based on the first metadata and the second metadata, the action tolerance breakpoint defining criteria for reducing an amount of a computing resource of the computing environment allocated to the workload; and
executing the workload in the computing environment while controlling allocation of the computing resource of the computing environment to the workload using the action tolerance breakpoint.

2. The system of claim 1, wherein the operation of executing the workload in the computing environment while controlling the allocation of the computing resource of the computing environment to the workload using the action tolerance breakpoint comprises:
detecting that the criteria defined by the action tolerance breakpoint is satisfied based on monitoring the workload; and
in response to detecting that the criteria defined by the action tolerance breakpoint is satisfied, reducing the amount of the computing resource of the computing environment allocated to the workload.

3. The system of claim 2, wherein the action tolerance breakpoint is a first action tolerance breakpoint, and wherein the operations further comprise generating a second action tolerance breakpoint defining criteria for terminating the workload.

4. The system of claim 3, wherein the operations further comprise:
subsequent to reducing the amount of the computing resource allocated to the workload, detecting that the criteria defined by the second action tolerance breakpoint is satisfied based on monitoring the workload; and
in response to detecting that the criteria defined by the second action tolerance breakpoint is satisfied, terminating the workload.

5. The system of claim 1, wherein the computing resource is selected from a group consisting of electricity, central processing unit (CPU) power, memory, storage, and graphics processing unit (GPU) power.

6. The system of claim 1, wherein the action tolerance breakpoint is an idle time threshold.

7. The system of claim 1, wherein the action tolerance breakpoint is an energy consumption threshold.

8. A computer-implemented method comprising:
receiving first metadata and second metadata, the first metadata describing at least one historical workload executed in association with an entity, and the second metadata describing a workload scheduled for execution in a computing environment;
generating an action tolerance breakpoint based on the first metadata and the second metadata, the action tolerance breakpoint defining criteria for reducing an amount of a computing resource of the computing environment allocated to the workload; and
executing the workload in the computing environment while controlling allocation of the computing resource of the computing environment to the workload using the action tolerance breakpoint.

9. The computer-implemented method of claim 8, wherein executing the workload in the computing environment while controlling the allocation of the computing resource of the computing environment to the workload using the action tolerance breakpoint comprises:
detecting that the criteria defined by the action tolerance breakpoint is satisfied based on monitoring the workload; and
in response to detecting that the criteria defined by the action tolerance breakpoint is satisfied, reducing the amount of the computing resource of the computing environment allocated to the workload.

10. The computer-implemented method of claim 9, wherein the action tolerance breakpoint is a first action tolerance breakpoint, and wherein the computer-implemented method further comprises generating a second action tolerance breakpoint defining criteria for terminating the workload.

11. The computer-implemented method of claim 10, further comprising:
subsequent to reducing the amount of the computing resource allocated to the workload, detecting that the criteria defined by the second action tolerance breakpoint is satisfied based on monitoring the workload; and
in response to detecting that the criteria defined by the second action tolerance breakpoint is satisfied, terminating the workload.

12. The computer-implemented method of claim 8, wherein the computing resource is selected from a group consisting of electricity, central processing unit (CPU) power, memory, storage, and graphics processing unit (GPU) power.

13. The computer-implemented method of claim 8, wherein the action tolerance breakpoint is an idle time threshold.

14. The computer-implemented method of claim 8, wherein the action tolerance breakpoint is an energy consumption threshold.

15. A non-transitory computer-readable medium comprising program code executable by a processing device for causing the processing device to perform operations comprising:
receiving first metadata and second metadata, the first metadata describing at least one historical workload executed in association with an entity, and the second metadata describing a workload scheduled for execution in a computing environment;
generating an action tolerance breakpoint based on the first metadata and the second metadata, the action tolerance breakpoint defining criteria for reducing an amount of a computing resource of the computing environment allocated to the workload; and
executing the workload in the computing environment while controlling allocation of the computing resource of the computing environment to the workload using the action tolerance breakpoint.

16. The non-transitory computer-readable medium of claim 15, wherein the operation of executing the workload in the computing environment while controlling the allocation of the computing resource of the computing environment to the workload using the action tolerance breakpoint comprises:
detecting that the criteria defined by the action tolerance breakpoint is satisfied based on monitoring the workload; and
in response to detecting that the criteria defined by the action tolerance breakpoint is satisfied, reducing the amount of the computing resource of the computing environment allocated to the workload.

17. The non-transitory computer-readable medium of claim 16, wherein the action tolerance breakpoint is a first action tolerance breakpoint, and wherein the operations further comprise generating a second action tolerance breakpoint defining criteria for terminating the workload.

18. The non-transitory computer-readable medium of claim 17, wherein the operations further comprise:
subsequent to reducing the amount of the computing resource allocated to the workload, detecting that the criteria defined by the second action tolerance breakpoint is satisfied based on monitoring the workload; and
in response to detecting that the criteria defined by the second action tolerance breakpoint is satisfied, terminating the workload.

19. The non-transitory computer-readable medium of claim 15, wherein the computing resource is selected from a group consisting of electricity, central processing unit (CPU) power, memory, storage, and graphics processing unit (GPU) power.

20. The non-transitory computer-readable medium of claim 15, wherein the action tolerance breakpoint is an idle time threshold.
